(19) United States
(12) Patent Application Publication
(10) Pub. No.: US 2026/0062056 A1
(43) Pub. Date: Mar. 5, 2026

(54) VEHICLE BODY STRUCTURE

(71) Applicant: TOYOTA JIDOSHA KABUSHIKI KAISHA, Toyota-shi (JP)

(72) Inventors: Shogo TOKUDA, Toyota-shi (JP); Takaaki ONODERA, Toyota-shi (JP); Soshiro MURATA, Toyota-shi (JP)

(21) Appl. No.: 19/262,129

(22) Filed: Jul. 8, 2025

(30) Foreign Application Priority Data
Aug. 29, 2024 (JP) 2024-148031

(51) Int. Cl. B62D 21/15

(52) U.S. Cl. CPC B62D 21/15

(57) ABSTRACT

A vehicle body structure is provided with an impact absorbing portion that includes plural areas, each of the plural areas having a different load bearing capacity corresponding to a stroke with respect to input of an impact load.

### CROSS-REFERENCE TO RELATED APPLICATION

This application is based on and claims priority under 35 USC 119 from Japanese Patent Application No. 2024-148031, filed on Aug. 29, 2024, the entire disclosure of which is incorporated by reference herein.

### BACKGROUND

### Technical Field

The present disclosure relates to a vehicle body structure.

### Related Art

WO 2022/0319191 discloses a vehicle body structure in which left and right wheel houses and cross members are integrally molded by casting.

### SUMMARY

It should be noted that as a vehicle body structure, it is generally necessary to absorb an impact force at the time of a vehicle collision.

Therefore, in cases in which an energy absorbing casting is provided in order to absorb an impact force in the above-mentioned prior art, it is difficult to control a breaking load at the time of a vehicle collision using the energy absorbing casting (impact absorbing portion) in various deformation modes.

In consideration of the above-described circumstances, an object of the present disclosure is to provide a vehicle body structure that enables a breaking load at the time of vehicle a collision to be controlled by an impact absorbing portion.

### Means for Solving the Problem

A vehicle body structure according to a first aspect is provided with an impact absorbing portion that includes plural areas, each of the plural areas having a different load bearing capacity corresponding to a stroke with respect to input of an impact load.

In the vehicle body structure according to the first aspect, the impact absorbing portion includes plural areas corresponding to a stroke with respect to input of an impact load, and a load bearing capacity with respect to input of the impact load is different in the plural areas. This enables load control to be achieved corresponding to a stroke with respect to input of an impact load. Namely, in the vehicle body structure according to the first aspect, impact energy can be effectively absorbed corresponding to a stroke with respect to input of an impact load, and as a result, entry of an impact load into a vehicle cabin can be suppressed.

A vehicle body structure according to a second aspect is the vehicle body structure according to the first aspect, wherein: the impact absorbing portion includes, along an input direction of the impact load, a low load area, a high load area, and a breakage suppression area; and the load bearing capacity increases in an order of the low load area, the high load area, and the breakage suppression area.

In the vehicle body structure according to the second aspect, the impact absorbing portion includes, along an input direction of the impact load, a low load area, a high load area, and a breakage suppression area. In the present disclosure, in the impact absorbing portion, the load bearing capacity with respect to input of an impact load is increased in the order of the low load area, the high load area, and the breakage suppression area.

This enables impact energy to be absorbed stepwise from at least the low load area to the high load area in the impact absorbing portion during a period until an impact load input from the vehicle outside is transmitted from a vehicle outer side to a vehicle inner side, thereby enabling a large impact value to not be input with respect to an occupant.

A vehicle body structure according to a third aspect is the vehicle body structure according to the second aspect, wherein a vehicle up-down direction cross-section height of the breakage suppression area is greater than a vehicle up-down direction cross-section height of the low load area and greater than a vehicle up-down direction cross-section height of the high load area.

In the vehicle body structure according to the third aspect, the vehicle up-down direction cross-section height of the breakage suppression area is greater than the vehicle up-down direction cross-section height of the low load area and greater than the vehicle up-down direction cross-section height of the high load area, and a section modulus of the breakage suppression area is higher than a section modulus of the low load area and the high load area. Therefore, a cross-section secondary moment of the breakage suppression area is larger than a cross-section secondary moment of the low load area and the high load area, and the breakage suppression area has a higher bending rigidity. This enables the breakage suppression area to be suppressed from being deformed more than the low load area and the high load area.

A vehicle body structure according to a fourth aspect is the vehicle body structure according to the second aspect, wherein: the impact absorbing portion is provided in a vehicle front-rear direction; and plural ribs that extend between an upper wall portion and a lower wall portion, which configure part of the low load area, and that are arranged along the vehicle front-rear direction, have a rigidity that increases from a front end of the low load area toward a rear end of the low load area.

In the vehicle body structure according to the fourth aspect, the impact absorbing portion is provided in the vehicle front-rear direction. Plural ribs extend between an upper wall portion and a lower wall portion, which configure part of the low load area, and the plural ribs are arranged along the vehicle front-rear direction. The pitch of the ribs becomes shorter from the front end of the low load area toward the rear end of the low load area, the wall thickness becomes thicker, and the like, for example, and a rigidity increases from the front end of the low load area toward the rear end of the low load area. Therefore, in the low load area, a crushing load gradually increases from the front end of the low load area toward the rear end of the low load area.

A vehicle body structure according to a fifth aspect is the vehicle body structure according to the second aspect, wherein, in the high load area, a vehicle up-down direction cross-section height gradually increases from the low load area toward the breakage suppression area.

In the vehicle body structure according to the fifth aspect, in the high load area, the vehicle up-down direction cross-section height gradually increases from the low load area toward the breakage suppression area, and a rigidity gradually increases from the low load area toward the breakage suppression area. This enables an absorption amount of impact energy to be gradually increased in the high load area, and enables a large impact value to not be input with respect to the occupant.

As explained above, the vehicle body structure according to the present disclosure enables a breaking load at the time of a vehicle collision to be controlled by the impact absorbing member.

### BRIEF DESCRIPTION OF THE DRAWINGS

FIG. 1 is a perspective view of a vehicle body structure according to an exemplary embodiment of the present disclosure, as viewed from a vehicle left oblique front side and upper side.

FIG. 2 is a side view illustrating a vehicle body structure according to an exemplary embodiment of the present disclosure.

FIG. 3 is an enlarged side view of relevant portions in FIG. 2, illustrating an impact absorbing portion that has been provided at a vehicle body structure according to an exemplary embodiment of the present disclosure.

### DETAILED DESCRIPTION

Explanation follows regarding a vehicle body structure according to an exemplary embodiment of the present disclosure, with reference to the drawings. It should be noted that in each of the drawings as appropriate, the arrow FR indicates a front side in a vehicle front-rear direction, and the arrow UP indicates an upper side in a vehicle up-down direction. The arrow LH indicates a left side in a vehicle width direction, and in the present exemplary embodiment, indicates a vehicle width direction outer side. In the following, in cases in which explanation is given simply using front-rear, up-down, and left-right directions, unless specifically stated otherwise, these refer to the front and rear in the vehicle front-rear direction, up and down in the vehicle up-down direction, and the left and right in a vehicle left-right direction (the vehicle width direction).

### Configuration of Vehicle Body Structure

First, explanation follows regarding a configuration of a vehicle body structure according to the present exemplary embodiment.

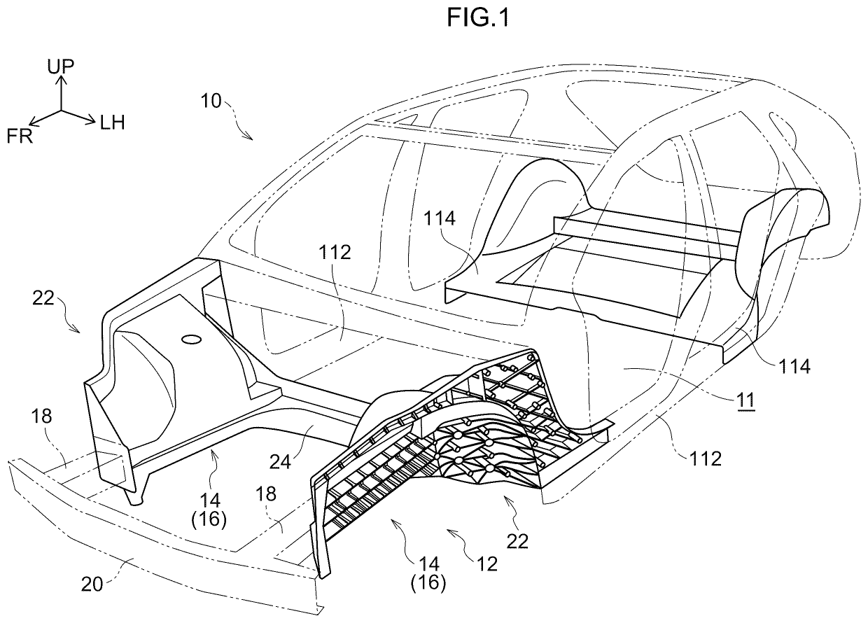

FIG. 1 is an overall view of a vehicle, which illustrates a skeleton of a vehicle 10. For example, although not illustrated in the drawings, the vehicle 10 is an electric vehicle, a fuel cell electric vehicle, or the like which runs on power that is generated by a power unit. As illustrated in FIG. 1, an impact absorbing portion 14, to which a vehicle body structure 12 according to the present exemplary embodiment has been applied, configures, for example, at least a portion of front side members 16. The front side members 16 are skeleton members at sides of the vehicle 10, and in the present exemplary embodiment, the front side members 16 are formed by casting using an aluminum alloy, a magnesium alloy, or the like as a material.

The front side members 16 are respectively disposed at each of a vehicle width direction left side and a vehicle width direction right side of a vehicle front portion, and each front side member 16 extends along the vehicle front-rear direction. The power unit is installed between the left and right front side members 16. Further, crush boxes 18, which are capable of absorbing impact energy, respectively extend along the vehicle front-rear direction at front sides of the left and right front side members 16, and a front bumper 20 extends along the vehicle width direction at front ends of the left and right crush boxes 18. It should be noted that although the front bumper 20 and the crush boxes 18 are described as separate components, the front bumper 20 and the crush boxes 18 may be configured so as to be integral with each other.

Wheel houses 22 in which wheels (not illustrated in the drawings) are disposed are respectively provided at each vehicle width direction outer side of the front side members 16, including the left and right front side members 16. Further, a right wheel house 22 and a left wheel house 22 are connected by a cross member 24. For example, the left and right front side members 16, the left and right wheel houses 22, and the cross member 24 may be integrally molded by casting.

### Impact Absorbing Portion

Explanation follows regarding the impact absorbing portion 14 that is provided at the vehicle body structure 12 according to the present exemplary embodiment.

In the present exemplary embodiment, the impact absorbing portion 14 is provided at the front side members 16. A cross-sectional shape of the front side members 16 when cut along the vehicle up-down direction and the vehicle width direction is substantially U-shaped with a vehicle width direction outer side as an opening.

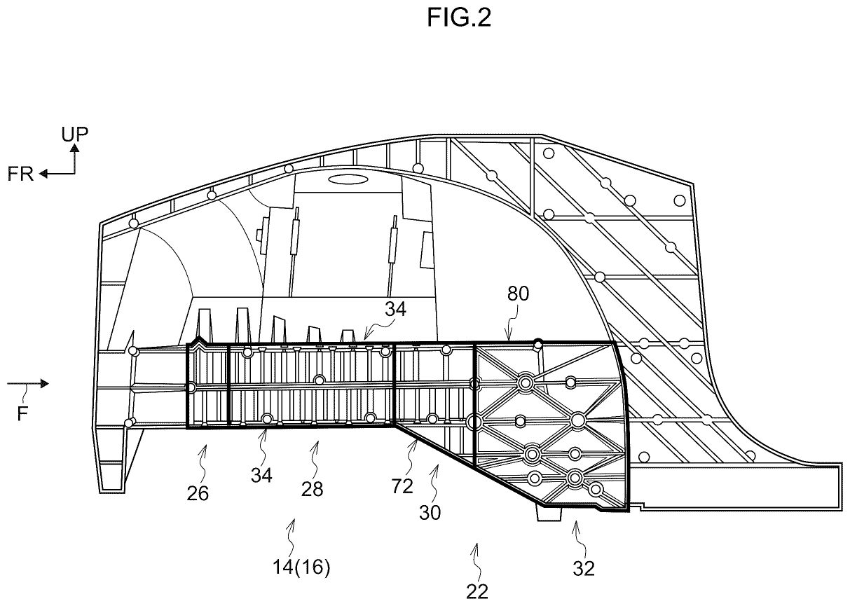

As illustrated in FIG. 2, the impact absorbing portion 14 includes, for example, a breakage starting area 26, a low load area (area) 28, a high load area (area) 30, and a breakage suppression area (area) 32, along an input direction of an impact load F. At the low load area 28, the high load area 30, and the breakage suppression area 32, a load bearing capacity with respect to input of the impact load F increases in this order.

The breakage starting area 26 is a crushing starting part of the impact absorbing portion 14, and the breakage starting area 26, the low load area 28, and the high load area 30 include, for example, a closed cross-sectional portion 34 having a substantially rectangular shape with a longitudinal direction along the vehicle front-rear direction in a vehicle side-on view. Further, the breakage starting area 26 and the high load area 30 are formed with a shorter stroke than the low load area 28. It should be noted that it is also possible to configure plural closed cross-sectional portions that are divided for each area.

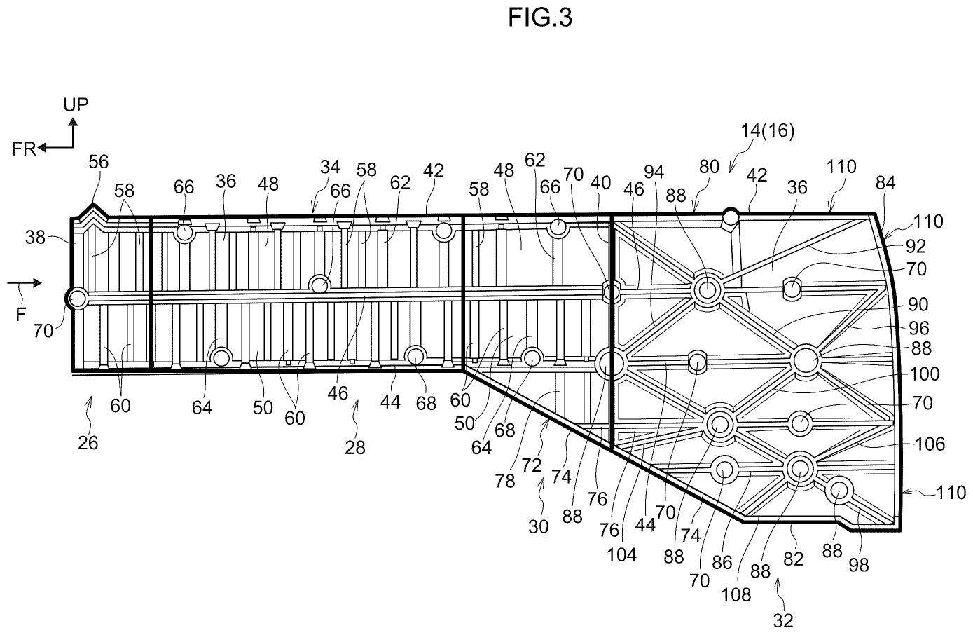

As illustrated in FIG. 3, the closed cross-sectional portion 34 includes a back wall portion 36 that is disposed at a vehicle width direction inner side, a vertical wall portion 38 that is installed upright toward a vehicle width direction outer side at a vehicle front-rear direction front end of the back wall portion 36, and a vertical wall portion 40 that is installed upright toward a vehicle width direction outer side at a vehicle front-rear direction rear end of the back wall portion 36.

Further, upper ends of the back wall portion 36, the vertical wall portion 38, and the vertical wall portion 40 are connected by a lateral wall portion (upper wall portion) 42, and lower ends of the back wall portion 36, the vertical wall portion 38, and the vertical wall portion 40 are connected by a lateral wall portion (lower wall portion) 44. Namely, the closed cross-sectional portion 34 is configured by the back wall portion 36, the vertical wall portions 38 and 40, and the lateral wall portions 42 and 44.

Up-down direction substantially central portions of the back wall portion 36, the vertical wall portion 38, and the vertical wall portion 40 are connected by a lateral wall portion 46, and the closed cross-sectional portion 34 is divided vertically into two levels, an upper-level portion 48 and a lower-level portion 50. It should be noted that in the following explanation, the same reference numerals are used for wall portions that are contiguously formed over plural areas, regardless of the area.

### Breakage Starting Area

First, a brief explanation follows regarding the configuration of the breakage starting area 26.

In the upper-level portion 48 of the breakage starting area 26, a vertical rib 58 extends in the up-down direction between the lateral wall portion 42 and the lateral wall portion 46, and in the lower-level portion 50 of the breakage starting area 26, a vertical rib 60 extends in the up-down direction between the lateral wall portion 46 and the lateral wall portion 44. Plural vertical ribs 58 and plural vertical ribs 60 are respectively arranged along the vehicle front-rear direction, and the vertical ribs 58 and the vertical ribs 60 are disposed offset in the vehicle front-rear direction. Namely, the vertical ribs 58 and the vertical ribs 60 are in a state of being noncontiguous in the up-down direction. It should be noted that the plural vertical ribs 58 and 60 may have different wall thicknesses depending on positions in the vehicle front-rear direction.

On the other hand, for example, a triangular notch portion 56 that projects toward an upper side is provided at the lateral wall portion 42 of the breakage starting area 26, and the notch portion 56 is a weak portion that is set with a lower rigidity than other parts. When an impact load F is input from the vehicle outside, and the impact absorbing portion 14 is crushed, the impact value increases at the start of crushing.

Therefore, providing the notch portion 56 at the breakage starting area 26 enables the notch portion 56 to be a starting point for crushing of the impact absorbing portion 14, and enables an impact value with respect to an occupant at the start of crushing to be reduced. Further, it is possible to suppress residual crushing at a front end portion at which crushing of the impact absorbing portion 14 starts, and to cause sequential crushing of the impact absorbing portion 14 from a front end of the impact absorbing portion 14.

It should be noted that the formation of the notch portion 56 is not limited to the lateral wall portion 42, as it is sufficient that the notch portion 56 is a starting point for the starting of crushing of the impact absorbing portion 14. Therefore, the notch portion 56 may be formed at a lateral wall portion 44 side.

### Low load Area

Explanation follows regarding the low load area 28, the high load area 30, and the breakage suppression area 32, in this order.

In a similar manner to in the breakage starting area 26, in the upper-level portion 48 of the low load area 28, a vertical rib 58 extends in the up-down direction between the lateral wall portion 42 and the lateral wall portion 46, and in the lower-level portion 50 of the low load area 28, a vertical rib 60 extends in the up-down direction between the lateral wall portion 46 and the lateral wall portion 44. Plural vertical ribs 58 and plural vertical ribs 60 are respectively arranged along the vehicle front-rear direction, and the vertical ribs 58 and the vertical ribs 60 are disposed offset in the vehicle front-rear direction and are in a state of being noncontiguous in the up-down direction.

In the low load area 28, the vertical ribs 58 and 60 respectively have a pitch that is shorter toward a vehicle rear side. Further, for example, among the vertical ribs 58, every second rib is a thick rib 62 having a thicker plate thickness, and among the vertical ribs 60, every second rib is a thick rib 64 having a thicker plate thickness.

A columnar boss 66 is provided at one end in the up-down direction of a portion of the thick rib 62 at an intersection point with the lateral wall portion 42 or the lateral wall portion 46. Further, a columnar boss 68 is provided at one end in the up-down direction of a portion of the thick rib 64 at an intersection point with the lateral wall portion 44. It should be noted that bosses 70 are respectively provided at intersection points with the lateral wall portion 46 at the vertical wall portions 38 and 40 which configure the closed cross-sectional portion 34.

These bosses 66, 68, and 70 are bases at which extrusion pins, which are not illustrated in the drawings, used when releasing a casted article from a mold, abut when molding the casted article including the front side members 16. Therefore, the bosses 66, 68, and 70 are disposed offset in the vehicle front-rear direction so as not to overlap with each other in the up-down direction, in order to release the casted article from the mold in a well-balanced manner. It should be noted that the bosses 66, 68, and 70 not only function as bases in contact with the extrusion pins, but may also be used as bases for fastening with other components.

### High Load Area

In a similar manner to in the low load area 28, in the upper-level portion 48 of the high load area 30, vertical ribs 58 extend in the up-down direction between the lateral wall portion 42 and the lateral wall portion 46, and in the lower-level portion 50 of the high load area 30, vertical ribs 60 extend in the up-down direction between the lateral wall portion 46 and the lateral wall portion 44. It should be noted that in a similar manner to in the low load area 28, thick ribs 62 and 64 and bosses 66, 68, and 70 are respectively provided inside the upper-level portion 48 and the lower-level portion 50 of the high load area 30.

Further, a closed cross-sectional portion 72 having a triangular shape in a vehicle side-on view is provided at a lower portion of the high load area 30. The closed cross-sectional portion 72 is provided with an inclined portion 74 that branches off from the lateral wall portion 44 of the low load area 28 and that is inclined downward toward the vehicle rear side, and each of the back wall portion 36 and the vertical wall portion 40, which configure the closed cross-sectional portion 34, extend to the inclined portion 74.

In this manner, in the present exemplary embodiment, the closed cross-sectional portion 72 is provided in addition to the closed cross-sectional portion 34, such that the cross-section height along the vehicle up-down direction gradually increases from the low load area 28 toward the breakage suppression area 32.

Further, a lateral wall portion 76 that branches off from the inclined portion 74 and that is formed substantially parallel to the lateral wall portion 44 is provided at a lower end side of the closed cross-sectional portion 72. Furthermore, vertical ribs 78 respectively extend between the lateral wall portion 44 and the inclined portion 74, and between the lateral wall portion 44 and the lateral wall portion 76. It should be noted that although the vertical ribs 78 are contiguously provided with respect to the vertical ribs 60 that are provided at the lower-level portion 50 of the high load area 30, the vertical ribs 78 may be disposed offset in the vehicle front-rear direction so as not to overlap with the vertical ribs 60 in the up-down direction.

### Breakage Suppression Area

The breakage suppression area 32 is formed with a stroke that is shorter than the low load area 28 and longer than the high load area 30, and the breakage suppression area 32 includes a closed cross-sectional portion 80 having a substantially rectangular shape with a longitudinal direction along the vehicle up-down direction in a vehicle side-on view. The closed cross-sectional portion 80 is formed adjacent to the closed cross-sectional portion 34 and the closed cross-sectional portion 72, and the vertical wall portion 40 of the closed cross-sectional portion 34 and the closed cross-sectional portion 72 is a vertical wall portion that is installed upright at a front end of the closed cross-sectional portion 80.

Further, the back wall portions 36 configuring the closed cross-sectional portions 34 and 72 are respectively formed contiguously with the back wall portion 36 of the closed cross-sectional portion 80. Furthermore, a front portion of a lower end of the back wall portion 36 of the closed cross-sectional portion 80 is formed contiguously with the closed cross-sectional portion 34 and the inclined portion 74 of the closed cross-sectional portion 72, and a lateral wall portion 82 is formed at a rear portion of the closed cross-sectional portion 80 along the vehicle front-rear direction.

Further, a vertical wall portion 84 that is installed upright at a vehicle front-rear direction rear end of the closed cross-sectional portion 80 is formed in a circular hole shape along the shape of the wheel house 22 (see FIG. 1). Namely, the closed cross-sectional portion 80 is configured by the back wall portion 36, the vertical wall portions 40 and 84, the lateral wall portion 42, the inclined portion 74, and the lateral wall portion 82. The cross-section height of the breakage suppression area 32 along the vehicle up-down direction is greater than the cross-section heights of the low load area 28 and the high load area 30 along the vehicle up-down direction.

Further, the lateral wall portions 44, 46, and 76 of the high load area 30 extend to the breakage suppression area 32, and are connected to the vertical wall portion 84. Furthermore, a lateral wall portion 86 is provided at an up-down direction substantially central portion between the lateral wall portion 76 and the lateral wall portion 82.

A cylindrical or columnar boss 88 is provided at a vehicle front-rear direction front portion side of the lateral wall portion 46 in the breakage suppression area 32, and the boss 88 is larger in diameter than the boss 70 provided in the high load area 30 and the like. Further, a boss 70 is provided between the aforementioned boss 88 and the vertical wall portion 84 at the lateral wall portion 46.

In the breakage suppression area 32, a boss 88 is provided at an intersection point of the vertical wall portion 40 and the lateral wall portion 44, and a boss 88 is provided at a vehicle front-rear direction rear side of the lateral wall portion 44, and a boss 70 is provided between the aforementioned bosses 88. Further, a boss 88 is provided at a vehicle front-rear direction front portion side of the lateral wall portion 76 in the breakage suppression area 32, and a boss 70 is provided between this boss 88 and the vertical wall portion 84.

Furthermore, a boss 70 is provided at a vehicle front-rear direction front portion side of the lateral wall portion 86, and a boss 88 is provided between this boss 70 and the vertical wall portion 84.

It should be noted that in the breakage suppression area 32, an intersection point of the vertical wall portion 40 and the lateral wall portion 42, and an intersection point of the lateral wall portion 76 and the vertical wall portion 84 are joined by a linear inclined rib 90. A boss 88 is provided on the inclined rib 90 at the lateral wall portion 46 and a boss 88 is provided on the inclined rib 90 at the lateral wall portion 44. When reversed, the bosses 88 are respectively provided at points at which the inclined rib 90 and each of the lateral wall portions 44 and 46 intersect with each other.

Further, an intersection point of the lateral wall portion 42 and the vertical wall portion 84, and the boss 88 provided at the lateral wall portion 46 are joined a linear inclined rib 92.

Furthermore, a boss 88 is provided at the intersection point of the vertical wall portion 40 and the lateral wall portion 44, and this boss and the boss 88 that is provided at the lateral wall portion 46 are joined by a linear inclined rib 94. In addition, the intersection point of the lateral wall portion 46 and the vertical wall portion 84, and the boss 88 that is provided at the lateral wall portion 44 are joined by a linear inclined rib 96.

In the breakage suppression area 32, the boss 88 that is provided at the intersection point of the vertical wall portion 40 and the lateral wall portion 44, and an intersection point of the lateral wall portion 82 and the vertical wall portion 84, are joined by a linear inclined rib 98. The boss 88 that is provided at the lateral wall portion 44 and the boss 88 that is provided at the lateral wall portion 86 are respectively provided on the inclined rib 98. In a similar manner to the inclined rib 90, when reversed, the bosses 88 are respectively provided at points at which the inclined rib 98 and each of lateral wall portions 76 and 86 intersect with each other. It should be noted that at the inclined rib 98, a boss 88 is further provided between the intersection point of the lateral wall portion 82 and the vertical wall portion 84, and the lateral wall portion 86.

On the other hand, the boss 88 that is provided at the vehicle front-rear direction rear side on the lateral wall portion 44 and the boss 88 that is provided at the lateral wall portion 76 are joined by a linear inclined rib 100, and the boss 88 that is provided at the lateral wall portion 76 and an intersection point of the vertical wall portion 40 and the inclined portion 74 are joined by a linear inclined rib 104. Further, the boss 88 that is provided at the lateral wall portion 86 and the intersection point of the lateral wall portion 76 and the vertical wall portion 84 are joined by a linear inclined rib 106. Furthermore, the aforementioned boss 88 and an intersection point of the inclined portion 74 and the lateral wall portion 82 are joined by a linear inclined rib 108.

In this manner, in the breakage suppression area 32, for example, the vertical wall portion 40, the lateral wall portion 46, and the inclined rib 90, and the lateral wall portion 42 and the inclined ribs 90 and 92 each form a triangular shape, and are each contiguously formed, thereby configuring a truss structure 110. It should be noted that in the present exemplary embodiment, in addition to these, contiguous triangular shapes are formed at respective parts by vertical wall portions, lateral wall portions, and inclined ribs, and the truss structure 110 includes plural levels (here, five levels).

### Operation and Effects of the Vehicle Body Structure

Explanation follows regarding operation and effects of the vehicle body structure according to the present exemplary embodiment.

As illustrated in FIG. 3, in the present exemplary embodiment, the impact absorbing portion 14 includes plural areas (the low load area 28, the high load area 30, and the breakage suppression area 32) corresponding to a stroke with respect to input of an impact load F, and a load bearing capacity with respect to input of the impact load F differs in the plural areas (the low load area 28, the high load area 30, and the breakage suppression area 32).

Therefore, in the present exemplary embodiment, the impact absorbing portion 14 is capable of achieving load control corresponding to a stroke with respect to input of an impact load F. In other words, in the present exemplary embodiment, a breaking load (load bearing capacity) of the vehicle 10 at the time of a collision can be controlled by the impact absorbing portion 14. As a result, in the present exemplary embodiment, the impact absorbing portion 14 is capable of effectively absorbing impact energy corresponding to a stroke with respect to input of an impact load F, and is capable of suppressing entry of the impact load F into a vehicle cabin 11 (see FIG. 1).

More specifically, in the present exemplary embodiment, the low load area 28, the high load area 30, and the breakage suppression area 32 are provided at the impact absorbing portion 14 along the input direction of the impact load F, and the load bearing capacity with respect to input of the impact load F is increased in the order of the low load area 28, the high load area 30, and the breakage suppression area 32.

As a result, impact energy can be absorbed stepwise from the low load area 28 to the high load area 30 in the impact absorbing portion 14 during a period until an impact load F input from the vehicle outside is transmitted from a vehicle outer side to a vehicle inner side, such that a breaking load is reduced correspondingly, and a deceleration G is reduced. This enables a large impact value to not be input with respect to an occupant.

Further, in the present exemplary embodiment, the cross-section height of the breakage suppression area 32 along the vehicle up-down direction is greater than the cross-section heights of the low load area 28 and the high load area 30 along the vehicle up-down direction, and a section modulus of the breakage suppression area 32 is higher than a section modulus of the low load area 28 and the high load area 30, and a cross-section secondary moment of the breakage suppression area 32 is larger than a cross-section secondary moment of the low load area 28 and the high load area 30. As a result, in the present exemplary embodiment, a bending rigidity is higher in the breakage suppression area 32 than in the low load area 28 and the high load area 30, such that deformation can be suppressed, and entry of the impact load F into the vehicle cabin 11 (see FIG. 1) can be suppressed.

In the present exemplary embodiment, at the impact absorbing portion 14, the vertical ribs 58 extend in the up-down direction between the lateral wall portion 42 and the lateral wall portion 46, and the vertical ribs 60 extend in the up-down direction between the lateral wall portion 46 and the lateral wall portion 44. As a result thereof, the rigidity of the impact absorbing portion 14 is increased, thereby enabling the load bearing capacity to be improved, and enabling an absorption amount of impact energy to be improved.

In the present exemplary embodiment, plural vertical ribs 58 and 60 are respectively arranged along the vehicle front-rear direction, and the vertical ribs 58 and the vertical ribs 60 are disposed offset in the vehicle front-rear direction and are in a state of being noncontiguous in the up-down direction. This causes the timing of breakage due to the vertical ribs 58 and 60 and the like to not coincide, enabling a breaking load to be reduced compared to a case in which the timing of breakage due to the vertical ribs 58 and 60 and the like is the same. Therefore, in the present exemplary embodiment, a load difference in a breaking load can be further suppressed, enabling an impact value that is generated with respect to an occupant at the time of breakage to be reduced.

Further, in the present exemplary embodiment, the vertical ribs 58 and 60 have a shorter pitch from a front end toward a rear end of the low load area 28. As a result, in the present exemplary embodiment, in the low load area 28, the span of Euler buckling becomes smaller from the front end toward the rear end, enabling a partial crushing load thereof to be increased.

Therefore, in the present exemplary embodiment, in the low load area 28, a crushing load (load bearing capacity) gradually increases from the front end toward the rear end of the low load area 28. This enables the absorption amount of impact energy to be gradually increased in the low load area 28, such that a large impact value is not input with respect to an occupant.

It should be noted that since it is sufficient that a crushing load gradually increases from the front end toward the rear end of the low load area 28, not only the pitch of the vertical ribs 58 and 60 may be changed, but also the wall thickness may be changed, or both may be changed. Further, the plate thicknesses of the lateral wall portions 42, 44, and 46 may be gradually increased from the front end toward the rear end of the low load area 28.

Further, in the present exemplary embodiment, in the high load area 30, the cross-section height along the vehicle up-down direction gradually increases from the low load area 28 toward the breakage suppression area 32. Therefore, in the high load area 30, a rigidity gradually increases from the low load area 28 toward the breakage suppression area 32. This enables the absorption amount of impact energy to be gradually increased in the high load area 30, and enables a large impact value to not be input with respect to an occupant.

Accordingly, in the impact absorbing portion 14, at least in the low load area 28 and the high load area 30, a load bearing capacity gradually rises along an input direction of an impact load F. This enables the impact absorbing portion 14 to be crushed sequentially from a front end portion toward a rear end portion in an input direction of the impact load F in the impact absorbing portion 14. Namely, the impact absorbing portion 14 is capable of suppressing residual crushing, and efficiently and sequentially absorbing impact energy from the front end to the rear end of the impact absorbing portion 14.

Incidentally, in the present exemplary embodiment, the front side members 16 are molded by casting. This enables a greater degree of freedom in design in the shape of the front side members 16 compared to molding by extrusion, for example, and improves manufacturing efficiency.

In the present exemplary embodiment, the left and right front side members 16, the left and right wheel houses 22, and the cross member 24 are integrally molded by casting.

Therefore, in the present exemplary embodiment, there is no need for fasteners for fastening the left and right front side members 16 and the left and right wheel houses 22, and the left and right wheel houses 22 and the cross member 24, respectively, thereby enabling the number of components to be reduced. It should be noted that these members do not necessarily have to be integral with each other, and each member may, of course, be molded as a single body.

In the above-described exemplary embodiment, although an example has been described in which the front side members 16 are formed by casting, the present disclosure is not limited thereto. For example, in addition to metal, the front side members 16 may be formed of carbon fiber reinforced plastics (CFRP). In such a case, the front side members 16 are formed, for example, by injection molding.

Further, in the above-described exemplary embodiment, although the front side members 16 have been described, the present disclosure can be applied to members other than the front side members 16. For example, the present disclosure may be applied to other skeleton members, such as a rocker 112, a rear side member 114 (see FIG. 1), and a suspension member that is not illustrated in the drawings. It should be noted that the input direction of the impact load varies depending on the skeleton member to which the present disclosure is applied. Further, in the impact absorbing portion, since plural areas each having a different load bearing capacity may be provided, two areas may be used.

Furthermore, in the present exemplary embodiment, a load bearing capacity with respect to input of the impact load F increases in the order of the low load area 28, the high load area 30, and the breakage suppression area 32 along the input direction of the impact load F; however, the present disclosure is not necessarily limited thereto. For example, the order may be changed by changing the stroke of each area.

Although an exemplary embodiment of the present disclosure has been described above, the present disclosure is not limited to such an embodiment, and obviously the exemplary embodiment and various modifications may be appropriately combined and used, and may be implemented in various forms within a range that does not depart from the gist of the present disclosure.

### Additional Notes

It should be noted that the vehicle body structure according to the present disclosure may be configured by appropriately combining the following configurations.

### Configuration 1

An impact absorbing portion is provided which includes plural areas, each of the plural areas having a different load bearing capacity corresponding to a stroke with respect to input of an impact load.

### Configuration 2

The impact absorbing portion is provided with, along an input direction of the impact load, a low load area, a high load area, and a breakage suppression area, and the load bearing capacity increases in an order of the low load area, the high load area, and the breakage suppression area.

### Configuration 3

In the impact absorbing portion, a vehicle up-down direction cross-section height of the breakage suppression area is greater than a vehicle up-down direction cross-section height of the low load area and greater than a vehicle up-down direction cross-section height of the high load area.

### Configuration 4

The impact absorbing portion is provided in a vehicle front-rear direction, and plural ribs that extend between an upper wall portion and a lower wall portion, which configure part of the low load area, and that are arranged along the vehicle front-rear direction, have a rigidity that increases from a front end of the low load area toward a rear end of the low load area.

### Configuration 5

In the high load area, a vehicle up-down direction cross-section height gradually increases from the low load area toward the breakage suppression area.

What is claimed is:

1. A vehicle body structure, comprising:
an impact absorbing portion that includes a plurality of areas, each of the plurality of areas having a different load bearing capacity corresponding to a stroke with respect to input of an impact load.

2. The vehicle body structure according to claim 1, wherein:
the impact absorbing portion includes, along an input direction of the impact load, a low load area, a high load area, and a breakage suppression area; and
the load bearing capacity increases in an order of the low load area, the high load area, and the breakage suppression area.

3. The vehicle body structure according to claim 2, wherein a vehicle up-down direction cross-section height of the breakage suppression area is greater than a vehicle up-down direction cross-section height of the low load area and greater than a vehicle up-down direction cross-section height of the high load area.

4. The vehicle body structure according to claim 2, wherein:
the impact absorbing portion is provided in a vehicle front-rear direction; and
a plurality of ribs that extend between an upper wall portion and a lower wall portion, which configure part of the low load area, and that are arranged along the vehicle front-rear direction, have a rigidity that increases from a front end of the low load area toward a rear end of the low load area.

5. The vehicle body structure according to claim 2, wherein, in the high load area, a vehicle up-down direction cross-section height gradually increases from the low load area toward the breakage suppression area.
